(19) United States
(12) Patent Application Publication
(10) Pub. No.: US 2010/0232630 A1
(43) Pub. Date: Sep. 16, 2010

(54) ACOUSTIC MULTI-POLE ARRAY AND METHODS OF PACKAGING AND CONTROLLING THE SAME

(75) Inventors: Sung Q Lee, Daejeon (KR); Hong Yeol Lee, Cheongju (KR); Hye Jin Kim, Daejeon (KR); Kang Ho Park, Daejeon (KR); Jong Dae Kim, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/684,833

(22) Filed: Jan. 8, 2010

(30) Foreign Application Priority Data
Mar. 16, 2009 (KR) 10-2009-0022309
Aug. 20, 2009 (KR) 10-2009-0076993

(51) Int. Cl. H04R 5/02

(52) U.S. Cl. 381/303

(57) ABSTRACT

Provided are an acoustic multi-pole array and methods of packaging and controlling the same. The methods include packaging first and second sound devices constituting an acoustic multi-pole array to have different sound characteristics or the same sound characteristic, arranging the first and second sound devices in tandem, and then respectively inputting sound sources having the same magnitude and different phases to the first and second sound devices to improve forward directivity and reduce a backward radiation characteristic.

### CROSS-REFERENCE TO RELATED APPLICATION

This application claims priority to and the benefit of Korean Patent Application Nos. 10-2009-0022309 filed Mar. 16, 2009 and 10-2009-0076993 filed Aug. 20, 2009, the disclosure of which is incorporated herein by reference in its entirety.

### BACKGROUND

1. Field of the Invention

The present invention relates to an acoustic multi-pole array and methods of packaging and controlling the same, and more particularly to an acoustic multi-pole array configured to have improved forward directivity and a reduced backward radiation characteristic and methods of packaging and controlling the same.

2. Discussion of Related Art

When ordinary speakers are used to output sound, many unspecified persons are acoustically disturbed due to the natural radiation of sound. For this reason, headphones or earphones are generally used as a personal sound system for minimizing acoustic disturbance affecting others and protecting personal life, but auditory isolation has been raised as a problem to be solved. Thus, personal sound equipment that can minimize acoustic disturbance affecting others and also solve the problem of auditory isolation is required.

As such personal sound equipment, a line speaker array that passes an audio signal through a digital filter having directivity and enables a user to hear sound at a predetermined position was disclosed.

However, the line speaker array requires filters installed in respective speakers. Thus, the structure becomes intricate with an increase in the number of speakers, and optimum filter coefficients must be calculated one by one to obtain optimum directivity at respective frequencies.

To solve these problems, an acoustic multi-pole array having a simple structure employing a directional sound device was disclosed as illustrated in FIG. 1.

However, respective sound devices included in such an acoustic multi-pole array have a sound characteristic varying according to packaging method, and thus variation of the sound characteristic must be considered when the acoustic multi-pole array is packaged, which will be described in further detail below.

FIGS. 2A and 2B illustrate a sound characteristic of a sound device varying according to packaging method.

When a structure 51 is packaged to surround only the lateral side of a first sound device P1 as illustrated in FIG. 2A, sound is radiated from the first sound device P1 not to the left or right side but to the front and back sides only. In other words, the first sound device P1 has a dipole sound characteristic.

Here, the sound radiation characteristic of the first sound device P1 may be expressed by the following Equation 1.

$$p ( r , θ , t ) = - i \frac{Q ρ c {k}^{2} d}{4 π r} cos ( θ ) {e}^{i ( ω t - kr )} \qquad [ Equation 1 ]$$

In Equation 1, r denotes a distance between the center of the first sound device P1 and the structure 51, θ denotes an angle between the center of the first sound device P1 and a hearing position, d(k*d<<1) denotes the length of the structure 51 surrounding the first sound device P1, and Q, ρ, c, k, and ω denote the intensity, density, speed of sound, wave number, and frequency of a sound source input to the first sound device P1, respectively.

On the other hand, when a structure S2 is packaged to surround the lateral side and back side of a second sound device P2 as illustrated in FIG. 2B, sound is radiated from the second sound device P2 to the left and right sides as well as the front and back sides. In other words, the second sound device P2 has a monopole sound characteristic.

Here, the sound radiation characteristic of the second sound device P2 may be expressed by the following Equation 2.

$$p ( r , θ , t ) = i \frac{Q ρ c k}{4 π r} {e}^{i ( ω t - kr )} \qquad [ Equation 2 ]$$

In Equation 2, r denotes a distance between the center of the second sound device P2 and the structure S2, θ denotes an angle between the center of the second sound device P2 and a hearing position, and Q, ρ, c, k, and ω denote the intensity, density, speed of sound, wave number, and frequency of a sound source input to the second sound device P2, respectively.

It can be seen from the above description that one sound device may have the dipole or monopole sound characteristic according to how the sound device is packaged.

Thus, when a sound device is packaged without consideration of variation of a sound characteristic, sound directivity of an acoustic multi-pole array may be reduced.

In particular, when an audio signal is output from an acoustic multi-pole array as shown in FIG. 1, the audio signal is heard loudly on the front side and almost not heard on the back, left and right sides, which indicates that a personal sound space is normally formed.

However, sound is unnecessarily output from a conventional acoustic multi-pole array to the back side also, and thus it is difficult to normally form a personal sound space.

### SUMMARY OF THE INVENTION

The present invention is directed to an acoustic multi-pole array configured to have improved forward directivity and a reduced backward radiation characteristic, and methods of packaging and controlling the same.

One aspect of the present invention provides a method of packaging an acoustic multi-pole array including: separately packaging first and second sound devices to have different sound characteristics or the same sound characteristic; and arranging the first and second sound devices in tandem to improve forward directivity and reduce a backward radiation characteristic.

Another aspect of the present invention provides a method of controlling an acoustic multi-pole array including: respectively inputting sound sources having the same magnitude and a phase difference of θ to first and second sound devices packaged to be arranged in tandem and have different sound characteristics or the same sound characteristic to improve forward directivity and reduce a backward radiation characteristic.

Still another aspect of the present invention provides an acoustic multi-pole array including: first and second sound devices arranged in tandem; and a phase and sound pressure adjuster for adjusting phases and sound pressures of sound sources respectively input to the first and second sound devices. The phase and sound pressure adjuster inputs the sound sources having the same magnitude and the different phases to the first and second sound devices packaged to have different sound characteristics or the same sound characteristic to improve forward directivity and reduce a backward radiation characteristic.

Here, the first sound device may be packaged to have a dipole sound characteristic, and the second sound device may be packaged to have a monopole sound characteristic, or both of the first and second sound devices may be packaged to have the monopole sound characteristic. And, the first sound device and the second sound device may have a number equal to or greater than one.

Also, the phases and sound pressures of the sound sources respectively input to the first and second sound devices may be adjusted to maximize an acoustic energy difference between a hearing space and a non-hearing space and a sound radiation efficiency of the first and second sound devices.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 illustrates a conventional acoustic multi-pole array;

FIGS. 2A and 2B illustrate a sound characteristic of a sound device varying according to packaging method;

FIGS. 3A to 3C illustrate methods of packaging and controlling an acoustic multi-pole array according to an exemplary embodiment of the present invention;

FIG. 4 illustrates the method of controlling an acoustic multi-pole array in detail according to an exemplary embodiment of the present invention; and

FIGS. 5A to 5C illustrate a method of controlling an acoustic multi-pole array according to another exemplary embodiment of the present invention.

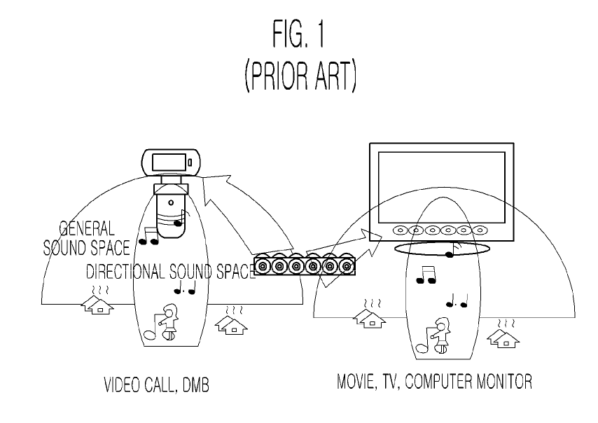

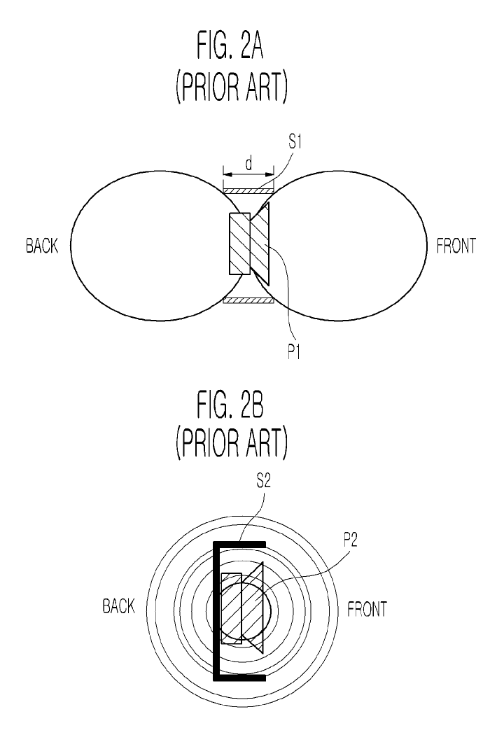

### DETAILED DESCRIPTION OF EXEMPLARY EMBODIMENTS

Hereinafter, exemplary embodiments of the present invention will be described in detail. However, the present invention is not limited to the embodiments disclosed below but can be implemented in various forms. The following embodiments are described in order to enable those of ordinary skill in the art to embody and practice the present invention.

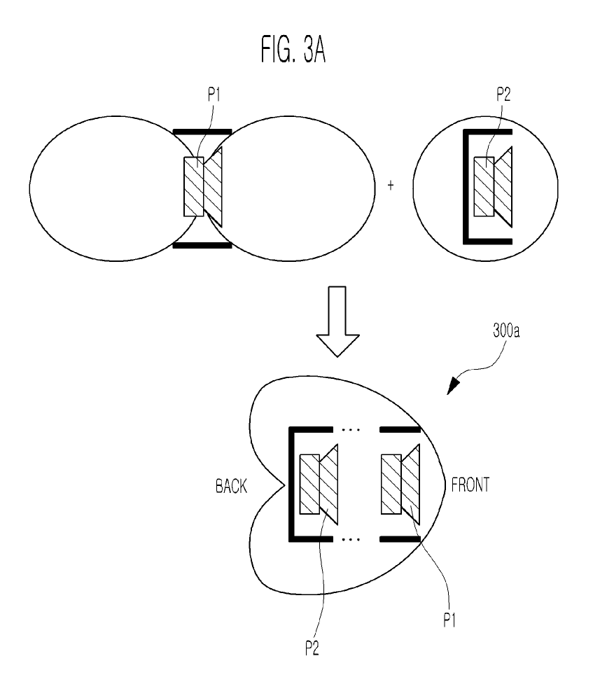

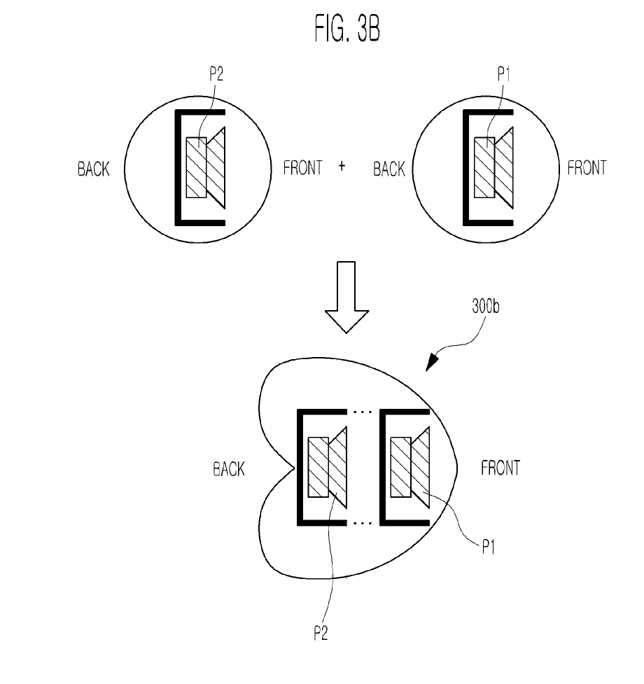

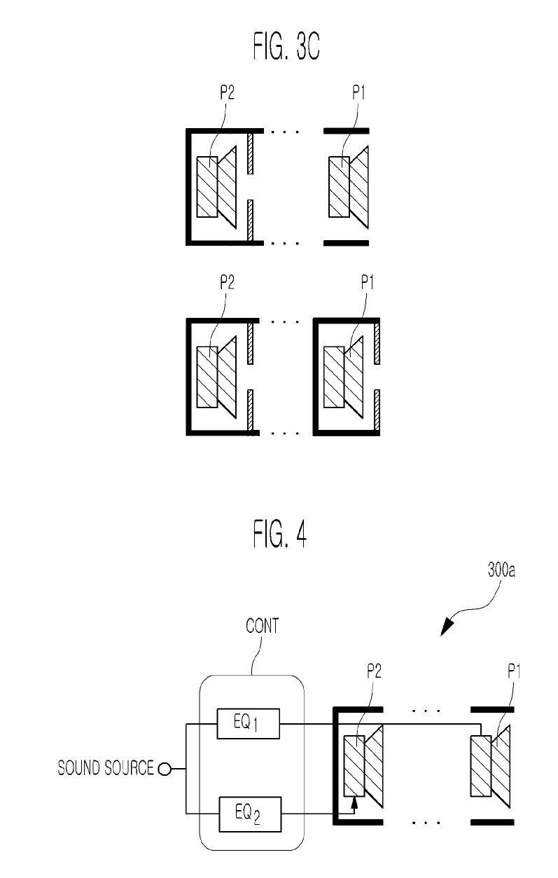

FIGS. 3A to 3C illustrate methods of packaging and controlling an acoustic multi-pole array according to an exemplary embodiment of the present invention.

Referring to FIG. 3A, a first sound device P1 is packaged to have a dipole sound characteristic, and a second sound device P2 is packaged to have a monopole sound characteristic.

As the first and second sound devices P1 and P2, voice coil speakers, piezoelectric speakers, ultrasonic transducers, etc., may be used.

Subsequently, the first sound device P1 and the second sound device P2 are arranged in tandem to constitute an acoustic multi-pole array 300a. In other words, the first sound device P1 is arranged in front of the second sound device P2.

At this time, the sound output direction of the first sound device P1 and the sound output direction of the second sound device P2 may correspond. And, a predetermined sound space or sound hall may be formed between the first sound device P1 and the second sound device P2.

When sound sources having the same magnitude and a phase difference of θ are respectively input to the first and second sound devices P1 and P2, two audio signals output from the first and second sound devices P1 and P2 are amplified to improve directivity on the front side and cancel each other to reduce a radiation characteristic on the back side.

In other words, according to an exemplary embodiment of the present invention, it is possible to implement a thin acoustic multi-pole array whose forward directivity is improved and backward radiation characteristic is reduced.

In the above-described exemplary embodiment, the first and second sound devices P1 and P2 are packaged to have different sound characteristics. However, both of the first and second sound devices P1 and P2 may be packaged to have the monopole sound characteristic, such that an acoustic multi-pole array 300b can be constituted as illustrated in FIG. 3B.

Also, as illustrated in FIG. 3C, to obtain the stronger monopole sound characteristic, the sound output terminal of the second sound device P2 may be packaged to be narrowed in the acoustic multi-pole array 300a, or the sound output terminals of the first and second sound devices P1 and P2 may be packaged to be narrowed in the acoustic multi-pole array 300b.

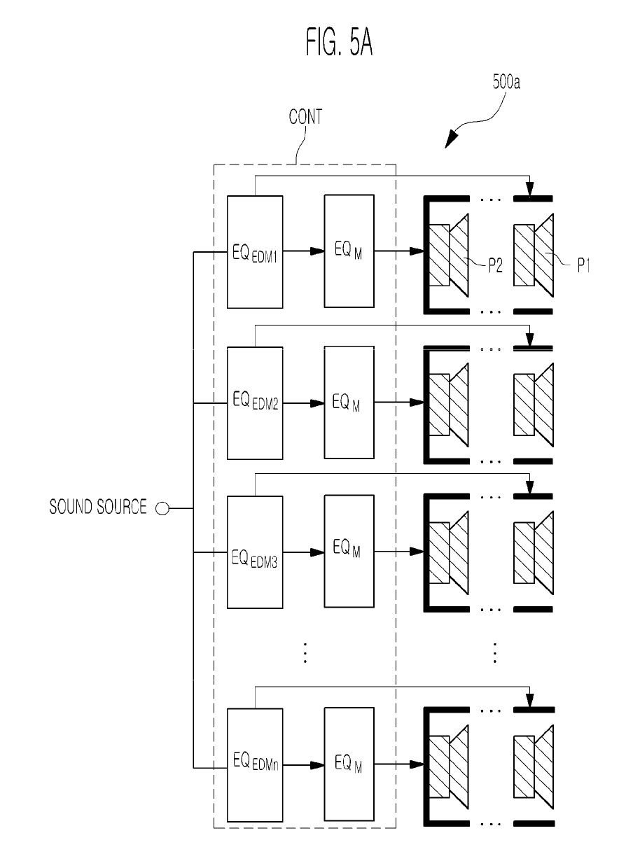

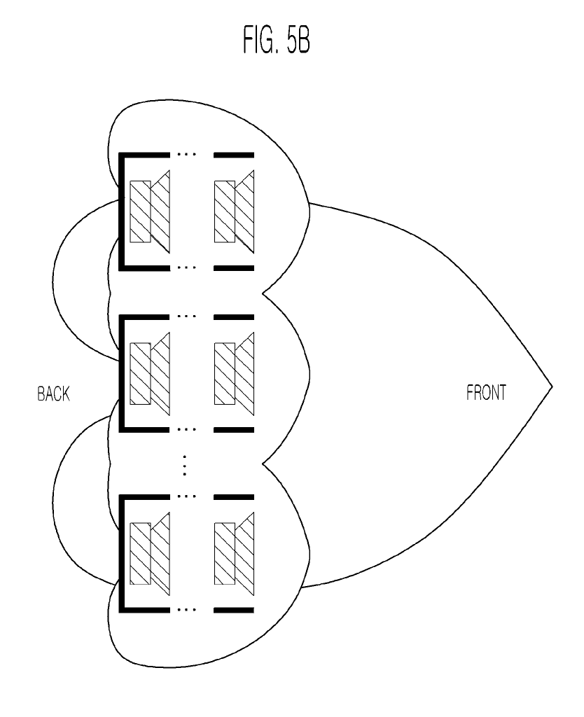

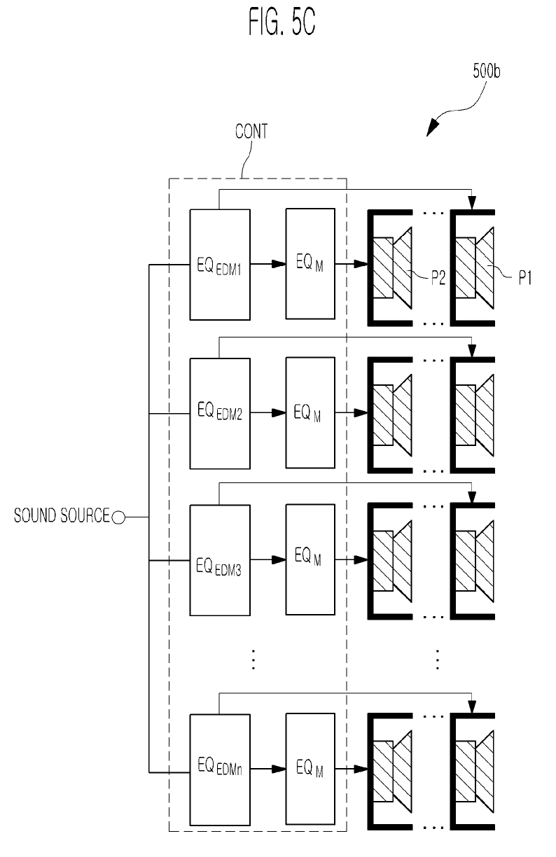

FIG. 4 illustrates the method of controlling an acoustic multi-pole array in detail according to an exemplary embodiment of the present invention.

Referring to FIG. 4, to improve the forward directivity of the acoustic multi-pole array 300a and reduce the backward radiation characteristic, sound sources having the same magnitude and a phase difference of θ must be input to the first and second sound sources P1 and P2, respectively.

However, when the first and second sound devices P1 and P2 are packaged, the sound characteristics of the first and second sound devices P1 and P2 may be distorted.

For example, a phase distortion of a may occur in the sound characteristic of the second sound device P2 when the first and second sound devices P1 and P2 are packaged. In this case, the phase distortion of a may occur while a sound source input to the second sound device P2 passes through the second sound device P2, and also the magnitude (sound pressure) of the sound source may be changed by the phase difference.

To compensate for such a distortion of a sound characteristic, an exemplary embodiment of the present invention adjusts the magnitude and phase of a sound source applied to the second sound device P2 with respect to a sound source applied to the first sound device P1 using a phase and sound pressure adjuster CONT.

To be specific, the phase and sound pressure adjuster CONT inputs a sound source EQ₁ having a magnitude of A₁ to the first sound device P1 and a sound source EQ₂ having a magnitude of A₂ and a phase changed by θ+α(α is a phase distortion caused by packaging) to the second sound device P2 as shown in Equation 3 below.

EQ₁=A₁

EQ₂=A₂*{cos(θ/2+α)+j*sin(θ/2+α)} [Equation 3]

In other words, even if distortion occurs in the sound characteristics of the first and second sound devices P1 and P2, when sound sources having the same magnitude and a phase difference of θ are respectively input to the first and sound sources P1 and P2 by the phase and sound pressure adjuster CONT, it is possible to compensate for the distortion of the sound characteristics of the first and second sound devices P1 and P2.

In the above-described exemplary embodiment, the magnitude and phase of a sound source applied to the second sound device P2 are adjusted with respect to a sound source applied to the first sound device P1. However, needless to say, the magnitude and phase of a sound source applied to the first sound device P1 may be adjusted with respect to a sound source applied to the second sound device P2.

FIGS. 5A to 5C illustrate a method of controlling an acoustic multi-pole array according to another exemplary embodiment of the present invention.

Referring to FIG. 5A, the first sound devices P1 are separately packaged to have the dipole sound characteristic, and the second sound devices P2 are separately packaged to have the monopole sound characteristic. Subsequently, each of the first sound devices P1 and each of the second sound devices P2 are arranged in tandem to constitute an acoustic multi-pole array 500a.

When sound sources having the same magnitude and a phase difference of θ are respectively input from the phase and sound pressure adjuster CONT to the first and second sound devices P1 and P2 after packaging of the acoustic multi-pole array 500a is completed, forward directivity is remarkably improved and a backward radiation characteristic is reduced as illustrated in FIG. 5B.

In the above-described exemplary embodiment, the first and second sound devices P1 and P2 are packaged to have different sound characteristics. However, both of the first and second sound devices P1 and P2 may be packaged to have the monopole sound characteristic, such that an acoustic multi-pole array 500b can be constituted as illustrated in FIG. 5C.

Meanwhile, to enable a hearer to hear sound in a hearing space only, an acoustic energy difference between a hearing space and non-hearing space and a sound radiation efficiency of the first and second sound devices P1 and P2 may be maximized.

Given that sound sources input to the first and second sound devices P1 and P2 are sound source vectors, a target function γ is defined as an acoustic energy difference E_{L}−E_{N} between a hearing space L and a non-hearing space N with respect to a total acoustic energy S^{H}S of the sound source vectors as shown in Equation 4 below to obtain optimum sound source vectors satisfying the two conditions.

$$γ = \frac{{E}_{L} - {E}_{N}}{{s}^{H} s} = \frac{1}{4 ρ {c}^{2}} \frac{{s}^{H} ( \begin{matrix}{R}_{L} - \\ {R}_{N}\end{matrix} ) s}{{s}^{H} s} \approx \frac{{s}^{H} ( \begin{matrix}{R}_{L} - \\ {R}_{N}\end{matrix} ) s}{{s}^{H} s} \qquad [ Equation 4 ]$$

Here, S^{H}S denotes the total acoustic energy of sound source vectors used to output sound (H is a Hermitian operator), R_{L}, denotes the degree of correlation between sound pressures generated in the volume of the hearing space L by different sound source vectors, and R_{N} denotes the degree of correlation between sound pressures generated in the volume of the non-hearing space N by different sound source vectors.

Thus, when sound source vectors causing the target function γ to have the largest value are set as optimum sound source vectors S and the sound pressures and phases of the sound sources respectively input to the first and second sound devices P1 and P2 are controlled according to the optimum sound source vectors S, sound can be heard using the minimum acoustic energy in the hearing space L only.

According to an exemplary embodiment of the present invention, it is possible to implement a thin acoustic multi-pole array whose forward directivity is improved and backward radiation characteristic is reduced. Thus, miniaturized apparatuses, such as cellular phones, can provide ambient sound effects without acoustically disturbing others.

Also, a sound output direction can be changed by adjusting the phases and sound pressures of sound sources respectively input to sound devices included in the acoustic multi-pole array.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of packaging an acoustic multi-pole array, comprising:
separately packaging first and second sound devices to have different sound characteristics or the same sound characteristic; and
arranging the first and second sound devices in tandem to improve forward directivity and reduce a backward radiation characteristic.

2. The method of claim 1, wherein separately packaging the first and second sound devices comprises packaging the first sound device to have a dipole sound characteristic and the second sound device to have a monopole sound characteristic.

3. The method of claim 2, wherein separately packaging the first and second sound devices further comprises packaging the first sound device to have the dipole sound characteristic represented by
$$p ( r , θ , t ) = - i \frac{Q ρ c {k}^{2} d}{4 π r} cos ( θ ) {e}^{i ( ω t - kr )}$$
where r denotes a distance between the center of a sound device and a structure, θ denotes an angle between the center of the sound device and a hearing position, d(k*d<<1) denotes the length of the structure surrounding the sound device, and Q, ρ, c, k, and ω denote the intensity, density, speed of sound, wave number, and frequency of a sound source input to the sound device, respectively.

4. The method of claim 2, wherein separately packaging the first and second sound devices further comprises packaging the second sound device to have the monopole sound characteristic represented by
$$p ( r , θ , t ) = i \frac{Q ρ c k}{4 π r} {e}^{i ( ω t - kr )}$$
where r denotes a distance between the center of a sound device and a structure, θ denotes an angle between the center of the sound device and a hearing position, and Q, ρ, c, k, and ω denote the intensity, density, speed of sound, wave number, and frequency of a sound source input to the sound device, respectively.

5. The method of claim 1, wherein separately packaging the first and second sound devices comprises packaging both of the first and second sound devices to have a monopole sound characteristic.

6. The method of claim 1, wherein arranging the first and second sound devices in tandem comprises arranging the first and second sound devices in tandem to improve the directivity on a front side by amplification of two audio signals output from the first and second sound devices and to reduce the radiation characteristic on a back side by canceling between the two audio signals output from the first and second sound devices.

7. The method of claim 1, wherein the first sound device and the second sound device have a number equal to or greater than one.

8. A method of controlling an acoustic multi-pole array, comprising:
respectively inputting sound sources having the same magnitude and a phase difference of θ to first and second sound devices packaged to be arranged in tandem and have different sound characteristics or the same sound characteristic to improve forward directivity and reduce a backward radiation characteristic.

9. The method of claim 8, further comprising, when distortion occurs in a sound characteristic of one of the first and second sound devices, adjusting a magnitude and a phase of a sound source input to one of the first and second sound devices with respect to a sound source input to the other sound device.

10. The method of claim 9, wherein adjusting the magnitude and the phase comprises, when distortion occurs in a sound characteristic of the second sound device, inputting a sound source having a first magnitude to the first sound device and a sound source having a second magnitude and a phase changed by θ+α(α is a phase distortion caused by packaging) to the second sound device.

11. The method of claim 8, wherein the first sound device and the second sound device have a number equal to or greater than one.

12. The method of claim 8, further comprising controlling the magnitude and phases of the sound sources respectively input to the first and second sound devices to maximize an acoustic energy difference between a hearing space and a non-hearing space and a sound radiation efficiency of the first and second sound devices.

13. An acoustic multi-pole array, comprising:
first and second sound devices arranged in tandem; and
a phase and sound pressure adjuster for adjusting phases and sound pressures of sound sources respectively input to the first and second sound devices,
wherein the phase and sound pressure adjuster inputs the sound sources having the same magnitude and the different phases to the first and second sound devices packaged to have different sound characteristics or the same sound characteristic to improve forward directivity and reduce a backward radiation characteristic.

14. The acoustic multi-pole array of claim 13, wherein the first sound device is packaged to have a dipole sound characteristic, and the second sound device is packaged to have a monopole sound characteristic.

15. The acoustic multi-pole array of claim 13, wherein both of the first and second sound devices are packaged to have a monopole sound characteristic.

16. The acoustic multi-pole array of claim 13, wherein the phase and sound pressure adjuster adjusts the phases and the sound pressures of the sound sources respectively input to the first and second sound devices to maximize an acoustic energy difference between a hearing space and a non-hearing space and a sound radiation efficiency of the first and second sound devices.

17. The acoustic multi-pole array of claim 13, wherein the first and second sound devices are voice coil speakers, piezoelectric speakers, or ultrasonic transducers.
